(19) United States
(12) Patent Application Publication
(10) Pub. No.: US 2017/0078361 A1
(43) Pub. Date: Mar. 16, 2017

(54) Method and System for Collecting Digital Media Data and Metadata and Audience Data

(71) Applicant: The Aleph Group Pte., Ltd., The Central (SG)

(72) Inventors: Venkateswaran Prasad, Dublin, CA (US); Sameer Pitalwalla, Mumbai (IN); Maduchhanda Das, Bangalore (IN); Ragavan Natarajan, Urapakkam (IN); Abhishek Tanksali, Mumbai (IN); Ravindra Jaju, Rahatani (IN)

(73) Assignee: The Aleph Group Pte., Ltd., The Central (SG)

(21) Appl. No.: 15/261,909

(22) Filed: Sep. 10, 2016

Related U.S. Application Data
(60) Provisional application No. 62/217,863, filed on Sep. 12, 2015.
(60) Provisional application No. 62/217,865, filed on Sep. 12, 2015.

(51) Int. Cl. H04L 29/08; H04L 12/26; H04L 29/06

(52) U.S. Cl. CPC H04L 67/02; H04L 65/4069; H04L 43/04

(57) ABSTRACT

Collecting media content data such as media content metadata, and audience viewing data, such as a list of videos whose statistics needs to be fetched from one or more repositories from a large number of data sources is implemented according to extensible multi-threaded data gathering framework, which involves utilizing a plugin-based extensible architecture, which delegates the site-specific responsibility to the plugin while at the core providing a fault-tolerant multi-threaded service on which the plugins are run to gather the data from the web.

### CROSS REFERENCE TO RELATED PATENT APPLICATIONS

The present application claims priority to U.S. provisional patent applications No. 62/217,863, and provisional patent application No. 62/217,865, both filed on Sep. 12, 2015, the content of each of which is included herein by reference. The present disclosure of the invention substantially shares its content with pending applications (Application Numbers to be inserted by amendment once determined), the content of each of which is hereby included by reference.

### FIELD OF THE INVENTION

The invention relates to collecting digital media data from a large network of distributed data sources, processing the data and serving digital media context data to creator users, more specifically the invention relates method for collecting metadata, including managing and caching network requests in a manner that avoids overloading the network with requests, indexing and storing the data in a database in a manner that allows a creator user to easily retrieve records based on time intervals.

### BACKGROUND OF THE INVENTION

The ease by which audiences can access digital media through networks has spurred the use of digital media as a means to directly communicate with audiences and with no delay between the creation of the media content and the delivery. In order to reach audiences and maintain a relationship with audiences (e.g., to provide marketing campaigns and/or sustain relationship with customers for a particular product), media content creators develop a resource (Channel) that can be accessed though a network, or customized communications (Electronic mail and/or messaging) to deliver media content to audience users.

For media content creators, the challenge is to develop media content that is relevant to their audience, that raises the audience attention, engaging (e.g., entices audience to take specific action in response to viewing the media content) and that is frequent enough in order to maintain an ongoing relationship. To produce content that fulfills these desired goals, the media content creators have to rely on their own creativity and experience, such as the accumulated knowledge of a given target audience for which the media content is created. Alternatively, the creator user may rely on data collected from viewers feedback. The creator user may receive feedback from audiences that viewed previous media content and study up-to-date information on the general interests of the audience. Once media content has been delivered, there is an opportunity to monitor streaming in real-time, collecting data about which content type is being accessed by audiences, trends of interest, user's feedback (e.g., recommendations between users), geographical areas etc.

A large number of media types is being used (e.g., written text, video, music, photos etc.) by users around the world. Each media content may be associated with several attribute types (e.g., movies, TV shows, radio shows etc.). In addition to the latter media data and the associated attribute data, other types of data may be gathered and processed, such as interaction of audiences with the digital media, the feedback that users may actively provide and other user behavior data that may be collected. Given the amount of raw data that can be amassed, gathering and utilizing such data presents numerous challenges, some of which are logistical and others are due the lack of know how.

Because of the large amount of data to process and the demand of delivering results in the shortest time possible, it is unfeasible to process the data manually, and may not be productive enough to enable the media content creators to develop media content at a satisfactory frequency to maintain a productive relationship with their audiences.

However, to process data and extract useful information that may be utilized by content creator, existing technologies remain rudimentary.

Therefore, there is a need for methods and systems for collecting, processing and distributing audience data to enable media content creators to create media content that is relevant and of interest to targeted audiences and within time delays that allows media content creators to generate new media content or frequently update existing media content.

### SUMMARY OF THE INVENTION

Media content creators significantly benefit from information about their audiences while creating new media content and/or updating existing one. The goal is to create media content that reaches the widest audiences and sustain relationships with audiences by making media content relevant, engaging and of interest to those audiences. To reach these goals, the media creator needs several types of information including, for example, the media content descriptors, the level of engagement from audiences, active feedback provided by viewing audiences, and other types of information that may be collected.

The invention discloses methods for implementing on a computer system to collect data from a large number of data sources. The methods of the invention allow a system to crawl a network accessing a plurality of site at once and managing the network while still fetching relevant data connections so as not to overload the network, while obtaining data stored on a plurality of data sources.

The invention discloses method steps, which may be implemented in a system, as an Extensible Multithreaded Data Gathering Framework that aims to address several challenges that arise when gathering large amounts of data, such as when collecting a list of brand names whose communication sources (e.g., Facebook page) needs to be retrieved, or a list of videos whose statistics needs to be fetched from one or more repositories on the Internet (e.g., YouTube), or any other textual data whose relevant information needs to be retrieved from the Internet. Implementations of the extensible multi-threaded data gathering framework, according to the invention, involves utilizing a plugin-based extensible architecture, which delegates the site-specific responsibility to the plugin while at the core providing a fault-tolerant multi-threaded service on which the plugins are run to gather the data from the web.

### BRIEF DESCRIPTION OF THE DRAWINGS

FIG. 1 is a flowchart diagram that represents the overall steps involved in providing data collection, audience data feature extraction and recommendation to creator users with the goal to build media that is of interest to a target audience.

FIG. 2 is a block diagram representing a system for collecting and processing data and providing input to creator users in accordance with an embodiment of the invention.

FIG. 3 is a flowchart diagram illustrating method steps for gathering and storing digital media metadata in accordance with an embodiment of the invention.

FIG. 4 is a block diagram representing functional components of the system implementing the extensible multithreaded data gathering framework in accordance with an embodiment of the invention.

FIG. 5 is a block diagram representing components of a data collection crawling system in accordance with an embodiment of the invention.

FIG. 6 is a block diagram representing components of a data collection crawling system further detailing a scheduling system in accordance with an embodiment of the invention.

FIG. 7 is a block diagram representing components of a data collection crawling system further detailing a queue management system in accordance with an embodiment of the invention.

FIG. 8 is a block diagram representing components of a data collection crawling system further detailing the crawler process instantiation and management system, the instance launcher system, the status and alert process management system and the data input/output system in accordance with an embodiment of the invention.

### DETAILED DESCRIPTION

The invention relates to method steps and a system for collecting media data, media metadata and audience experience data from a large network of data sources, analyzing the data, and extracting pertinent information that is partitioned and stored on a database in a manner that allows a creator user to query the data using time frames. One or more method steps, according to the invention, may be carried out in real-time, and/or the output information may be distributed on-demand and/or be joined to specific content delivered to a creator user.

In the following description, numerous specific details are set forth to provide a more thorough description of the invention. It will be apparent, however, to one skilled in the pertinent art, that the invention may be practiced without these specific details. In other instances, well known features have not been described in detail so as not to obscure the invention.

The following detailed description is shared and refers to co-pending patent application (number: to be determined), entitled: Method and System for Generating Video Content, which is included herein in its entirety by reference.

### Terminology

Unless otherwise specifically defined, terms, phrases and abbreviations used in this disclosure are commonly known in the art of information technology and computer programming and may be in use in one or more computer programming languages and the definition of which is available in computer programming dictionaries. However, the use of the latter terms, phrases and abbreviation in the disclosure is meant as an illustration of the use of the concept of the invention and encompasses all available computer programming languages provided that the terms, phrases and abbreviations refer to the proper computer programming instruction(s) that cause a computer to implement the invention as disclosed. Prior art publications that define the terms, phrases and abbreviations are included herein by reference.

In the following, systems implementing the invention, unless otherwise specifically indicated, comprise a client machine and/or server machine and any necessary link, such as an electronic network. Client machines comprise such devices as personal computers (e.g., a laptop or desktop etc.), hardware servers, virtual machines, personal digital assistants, portable telephones, tablets, or any other device. The client machines and servers provide the necessary means for accessing, processing, storing, transferring or otherwise carrying out any type of data manipulation and/or communication.

The methods of the invention enable the system, as each implementation of the invention may require, to remotely of locally query, access and/or upload data from/onto a network resource, such a World Wide Web (WWW) location using, for example, the Internet as a network.

A machine in the system (e.g., client and/or server machine) refers to any computing machine enabling a user or a program process to access a network and execute one or more steps of the invention as disclosed. For example, a machine may be a User Terminal such as a stand alone machine or a personal computer running an operating system such as, MAC-OS, WINDOWS, UNIX, LINUX, or any other available operating systems. A machine may be a portable computing device, such as a smart phone or tablet, running a mobile operating system such as iOS, Android or any other available operating system. A Host Machine may be a server, control terminal, network traffic device, router, hub, or any other device that may be able to access data, whether stored on disk and/or memory, or simply transiting through a network device. A machine is typically equipped with hardware and program applications for enabling the device to access one or more networks (e.g., wired or wireless networks), storage means for storing data (e.g., computer memory) and communicating means for receiving and transmitting data to other devices. A machine may be a virtual machine running on top of another system, e.g., on a stand alone system or otherwise in a distributed computing environment, to which it is commonly referred as cloud computing.

A “user” as used in this disclosure refers to any person using a computing device, or any process (e.g., a server and/or a client process) that may be acting on behalf of a person or entity to process and/or serve data and/or query other devices for specific information. In specific instances, an “audience user” may refer to a user accessing digital media, for simply viewing the content of the media and/or interacting with the media (e.g., writing comments, sending messages to other users regarding the media content etc.).

In other instances, the disclosure refers to a “creator user” as being a user who utilizes the output of the system implementing the invention (e.g., feedback information such as viewership statistics) to create new digital media. A “creator user” is enabled to carry out any type of data manipulation, such as filming new videos, altering existing videos or audio data or any other manipulation of digital media.

In the following disclosure, a Uniform Resource Locator (URL) refers to the information required to locate a resource accessible through a network. On the Internet, the URL of a resource located on the World Wide Web (WWW) usually contains the access protocol, such as HyperText Transport Protocol (HTTP), an Internet domain name for locating the server that hosts the resource, and optionally the path to a resource (e.g., a data file, a script file, and image or any other type data) residing on that server.

An ensemble of resources residing on a particular domain, and any affiliated domains or sub-domains, are typically referred as a World Wide Web site (or “website” in short). For example, data documents, stylesheets, images, scripts, fonts, or other files are referred to as resources.

Resources of a website are typically remotely accessed through an application called “Browser”. The browser application is capable of retrieving a plurality of data type from one or more resource locations, and carrying out all the necessary processing to present the data to the user and allow the user to interact with the data.

A Browser may automatically conduct transactions on behalf of the user without specific input from the user. For example, the browser may retrieve and upload uniquely identifying data (commonly referred as “cookies”), from and to websites.

Typically, an operator of (or process executed on) a machine may access a website, for example, by clicking on a hyperlink to the website. The user may then navigate through the website to find a web page of interest. Public information, personal information, confidential information, and/or advertisements may be presented or displayed via a browser window in the machine or by other means known in the art (e.g., pictures, video clips, etc.).

In the following disclosure, communication means (e.g., websites) specialized in providing tools for users to communicate with one another, or a user with a group of other users, share data or simply access a stream of digital data, are typically referred as social media.

While describing video content in the following, “content format” may be used to refer to the category of the topic covered in a video. For example, a video may be a guide to use a machine, in which case, the video can be categorized in the “how-to” category. Similarly, other topic categories may be “review”, “parody”, “unboxing”, “advertisement” or any other topic category.

Throughout the disclosure the term “real-time” should be construed while taking into consideration the context of data processing in which the term is used. For example, “Real-time” may refer to a time lapse of seconds of fractions thereof in the context of making network requests or accessing a record on a database; whereas “real-time” in the context of obtaining statistical aggregates data of which media content is attracting users' attention, “real-time” may refer to time lapses of hours, days, weeks or even months.

### Overview of the Concept

Collecting audience feedback data is at the basis of method steps of the invention. The data may be collected through direct feedback, such as by surveying viewers of a digital content, or indirectly such as by collecting users opinions expressed through various discussions online, which may indeed be a true reflection of how they feel at the time, what interests them, what they reject etc. Several platforms may be a source of collecting audience data. Social media/forums are examples of such source.

The invention provides the tools by which a creator user can collect the data, and process the data in order to generate meaningful recommendations that help the creator user generate new media content. The goal is that the new media content made for a target audience is of high quality and captures the interest of that target audience such that the rate of success of a digital content is improved.

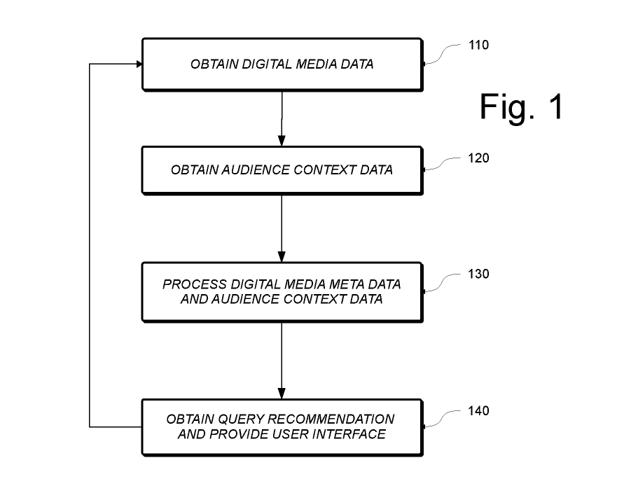

FIG. 1 is a flowchart diagram that represents the overall steps involved in providing data collection, audience data feature extraction and recommendation to creator users with the goal to build media that is of interest to a target audience.

At step 110, a system implementing the invention obtains the media data that may be viewed by audiences. The media data may be internally processed to obtain metadata (e.g., stored keywords), obtain image/video data of identifiable objects and/or scenes by analyzing video data (e.g., pictures of faces or architectural structures etc.), text data which may be stored as pictures of text which can be retrieved using character recognition methods, or any other type of data that may be obtained from a media content.

At step 120, embodiments of the invention collect audience data. Audience data may be any passive or active interaction of the users with the media content. Passive interaction may mean, for example, the simple viewing of a media content, the time spent viewing the media, the number of times the media was viewed by a particular viewer, the other media contents viewed in the same session or any other type of data that may be collected from the viewer without the viewer specifically contributing information. Alternatively, the viewer may actively input data (e.g., text feedback, image or video upload), which may also be collected and processed. In embodiments of the invention, step 120 may involve installing a plugin capable of gathering user experience data and communicating with a data collection resource for gathering, processing and storing the data.

At step 130, an embodiment of the invention processes the collected data, which is partitioned, indexed and stored in a database in a manner that facilitates finding results to queries submitted by creator users. Step 130 may be conducted on the data collection resource described above, and may also host a server for serving data to creator users.

At step 140, embodiments of the invention provide query recommendations, obtain queries from creator users and provide results from stored processed data. In order to provide a creator user with specific information of what to create and maximize audience interest in the media product, embodiments of the invention provide what will be referred herein as Content Recipes. Content recipes enable creator users perform at least the following tasks: a) Identify which content formats are performing well for an industry/domain of concern; b) Break the content formats down to a time-sliced window to identify patterns or emergence of patterns; c) obtain a detailed breakdown of which formats are doing well from a viewership or engagement standpoint; and d) Identify any emerging content format which is rising in popularity with a target audience, so that a determination can be made whether to invest in that emerging format.

Moreover, embodiments of the invention further enable creator users to build upon past experiences with audience and plan a strategy to make regular and frequent provision of content, which media is varied and enticing to keep contact with the media channel/source.

The invention provide method steps, which may be implemented in a system, as an Extensible Multithreaded Data Gathering Framework that aims to address several challenges that arise when gathering large amounts of data, such as when collecting a list of brand names whose communication sources (e.g., Facebook page) needs to be retrieved, or a list of videos whose statistics needs to be fetched from one or more repositories on the Internet (e.g., YouTube), or any other textual data whose relevant information needs to be retrieved from the Internet. An embodiment of the invention may implement the extensible multi-threaded data gathering framework by means of a plugin-based extensible architecture delegating the site-specific responsibility to the plugin while at the core providing a fault-tolerant multi-threaded service on which the plugins are run to gather the data from the web.

### System for Collecting and Processing Digital Media Audience Data

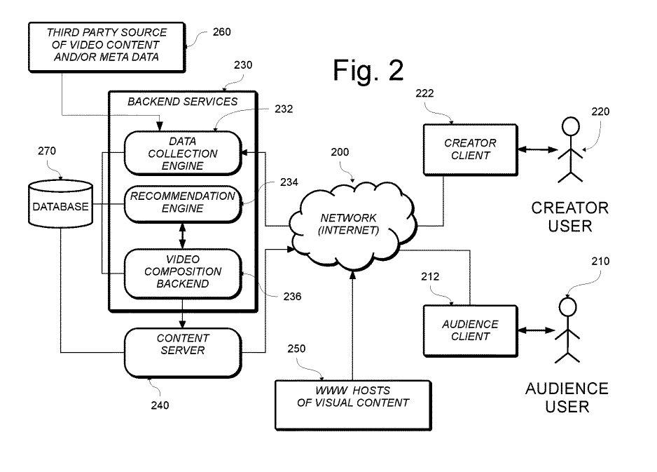

FIG. 2 is a block diagram representing a system for collecting and processing data and providing input to creator users in accordance with an embodiment of the invention. Each block in FIG. 2 represents sets of system components (software and hardware) and method steps embodied in computer program code that when executed achieve the functional results as described below. The several components may be localized in a single machine or distributed across multiple machines, sites and/or platforms. The latter machine may remotely communicate over a network (e.g., 200) such the Internet.

A system embodying the invention comprises backend services components (e.g., 230) for collecting, processing, storing and retrieving data; a recommendation engine (e.g., 234) for receiving queries from creator users (e.g., 210); and back-end media content composition (e.g., 236) for enabling creator users to generate new media content. The data may be collected from third party sources of media content data (e.g., 260). The data may be collected from plugin/application components that are executed on a plurality of audience user machines (e.g., 212). The data is preferably stored in a database (e.g., 270), which designed with novel indexing method steps that allows for retrieval of data optimal for the creator user to access the most pertinent information for creating new media content.

The system comprises a data collection engine 232 comprising the system components that collect data, organize the data in order to facilitate further processing. The data collection engine obtains more data about a set of input data from the world wide web. The set of input data comprises all metadata and media statistics data (e.g., number of views, number of likes etc.) about all videos present in the digital space (e.g., 250), online activity of users on any data source (e.g., contributed activity data on online usergroups) to understand their current behavior and interests, topical events which are the topic of interest of the target data source (e.g., usergroup). For example, the audience user data may be collected in real-time as the viewers retrieve the media content and as they input comments, discussion, simultaneously or successively visit other media content or carry out any other behavior that may be associated with the access to a particular media content.

The data collection engine may also retrieve data from third party providers (e.g., 260). The latter may be one or more repositories that contain information about any particular media stream, audience data or any other type of data that may be pertinent for the data collection and processing as provided by implementations of the invention. For example, the third-party repositories may provide data indicating which type media content, topic or any other data distributed to users are showing an increase (or decrease) in interest. The latter is typically referred a a “trending” in the distribution of media content.

A system according to the invention comprises a set of (software and hardware) components that enable the system to process the collected data and build a back-end resource to allow the system to make recommendations to a creator user to generate new content.

A system according to the invention comprises a video composition back-end, which is a set of (software and hardware) components that enable a user to produce digital content. A creator user, for example, is able to use the system to learn about the content a target audience is watching, what different kind of content is appeasing to the various audience fragments or any other information that may lead a creator use in generating content of interest to a give audience.

### Data Collection Methods

Embodiments of the invention obtain a maximum amount of input data (e.g., media) from the world wide web. While the underlying task is common, which is to obtain information about a set of data from the world wide web, a program doing so could face many challenges. For example, the input data set could often exceed hundreds millions of records demanding a main system memory capacity that exceeds feasible limits. In addition, accessing a target data source on the Internet may need to comply with restrictions such as the maximum number of requests per second it may be served, and/or total number of requests per day, etc, which may be imposed by the source of data (e.g., third-party data sources). A page may in addition demand other information/actions, such as constantly refreshing security tokens needed for authorization etc.

Data collection may face other challenges, such as arbitrary timeouts that could occur for various reasons including server errors, client errors, errors caused due to network outage etc. In addition, the dynamic behavior of certain websites might demand the data gathering code to take certain actions in order to be able to retrieve certain information. For example, it might paginate the results with token identifications, forcing the data retrieval code to repeatedly request the pages that provide token identifications to be able to reach the proper content.

Embodiments of the invention implement a set of novel methods to crawl a network in order to collect data. Crawling refers to the process of sequentially accessing network resources (e.g., data on a website). Accessing network resources may be simultaneously carried out from a plurality of processes executing on a given machine or (e.g., in a distributed environment) launched from several machines. The process of gathering data (i.e. crawling) must be managed in order to maximize the speed of data collection and the amount of data while minimizing the load put on the network.

The methods of the crawler in accordance with embodiments of the invention may involve gathering the resource locations (e.g., web site URLs), creating queues of network connections in order to send requests to any specific URL, and managing the queues of connections in order to optimize network traffic and avoid overloading the network. The methods are implemented within a framework designed to facilitate development of software components, and further allows to expand functionality of the software to grow the set of tools offered by a system implementing the invention.

The system, according to the invention, may be configured to carry out any kind of web-crawling while minimizing the amount of program code (no more than few tens of lines) could be written and be plugged in this architecture. The user can configure the limits (such as the number of HTTP requests per seconds) at which to crawl.

The uniqueness of this crawler is its ability to read the input from an input-stream to construct similar outgoing HTTP requests with varying set of input parameters (such as video id.) and its ability to do it in fixed batch size. For example, the framework may read the input data as a stream from text file in batches into memory, wherein a typical batch size may be less than 100 entries. This makes it possible to deal with very large number of records at input.

When a response is received for some items in the batch, new items are added to the batch without waiting for the entire batch to complete (the batch can be seen as a sliding window from begin to end in the input stream of request ids—as soon as one is complete, causing the batch size to drop, the next one is taken immediately for processing). The latter ensures that the batch size remains constant throughout the run. Failed requests can be retried as many number of times as the user wants before being marked as permanent failure (for valid reasons). The failed requests may be tried only after all the input in the input-stream is exhausted.

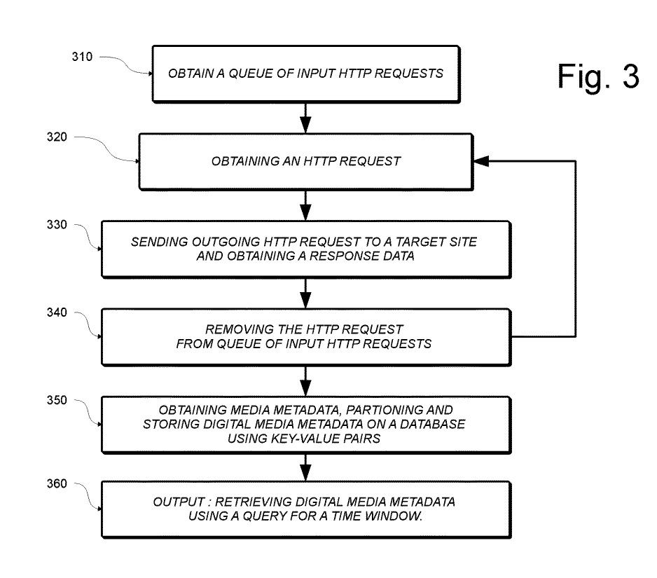

FIG. 3 is a flowchart diagram illustrating method steps for gathering and storing digital media metadata in accordance with an embodiment of the invention. At step 310, an embodiment of the invention may load a plurality of input HyperText Transport Protocol (HTTP) request data from at least one data stream into a computer memory as at least one batch for processing. Input HTTP request data may be loaded as batches of from one or more of text files, database queries, network storage locations or any other source for obtaining data. Batches of input request data may be set to maximum size so as to avoid overloading a system embodying the invention carrying out the crawling steps.

At step 320, the system obtains a HTTP request from said plurality of input HTTP request data. The HTTP request may contain a target site data and further optionally contains at least one varying request parameter. An outgoing HTTP request may be constructed by modifying the parameters of request to seek a specific type of data. The outgoing HTTP request may be modified by adding to it an identifier for identifying a video media content on a target site.

For example, the outgoing request can be modified to adapt to then-current operating conditions or restrictions imposed by the target server that is being sent the request. For example the requested number of response elements expected in a response can be modified in order to maximize the information content in the response relative to the amount of request quote units consumed in response processing.

Below is an example of the type of processing that may be undertaken in generating an outgoing HTTP request. In a message-driven queuing mechanism where a job in the queue contains a message (record) to be processed, the message is the source of parameters required to execute the request. A worker job picks the message from the queue and creates an outgoing HTTP requests and executes the query.

A typical outgoing HTTP request may contain the following elements:

{operation} {protocol} {domain} {endpoint} {endpointversion} {entity} {dimension/parts} {parameters}

{operation} refers to operation instructions destined for the server e.g., GET, POST, DEL. To fetch data a GET query operation may be used.

{protocol} refers to the network access modality for communicating with a server e.g., HTTP and or HTTPS

{domain} is a network domain name which is used to identify the numerical reference of server on a network. Numerical references (e.g., Internet Protocol addresses may be directly used for the latter identification.) For example a the domain name may be “www.googleapis.com”

{endpoint} refers to the api endpoint of the primary source. For example, an endpoint called “youtube” may be used to reach the youtube endpoint via google api.

{endpointversion} refers to the version of the endpoint being accessed. e.g. “v3” may refer to version 3.

{entity} refers to the actual object/entity for which we are interested to fetch data. E.g. ‘videos’ is the api that we will use to fetch data around videos object

{parameters} refers to a plurality of parameters that be passed to the server. For example, {dimension/parts} may represent the dimension of the api identity. This is selected as per the crawler logic and can vary in order to ensure the rate limits are respected with every outgoing HTTP call; {fields} like parts or dimensions we might choose specific fields of interest for a particular call. This is selected as per the need of the respective crawler and defined by the application's logic; {entityid} the identifier that identifies the entity; {authkey} the availed authorization key for making the HTTP call.

A typical request may be formatted as follows: “GET https://www.googleapis.com/youtube/v3/videos?part=snippet&id=ID&key=APIKEY”

At step 330, a system embodying the invention sends out the outgoing HTTP request to a target site. In response the system may receive a response, which returns data containing a digital media metadata. If the connection request to a target resource fails, the system may retry the connection request for a set number of times. If after a number of trials, the specific entry from the a batch of input requests may labeled as a permanent failure.

Embodiments of the invention may throttle outgoing HTTP request per time unit in order to avoid overloading any particular target site.

Moreover, in sending out connection requests, an embodiment of the invention may manage one or more queues of connections each queue is filled with a plurality of requests to be connected. Instances are created to handle each request. At step 340, an embodiment of the invention removes the request from the queue and loads one or more input HTTP requests from one or more data streams into the queue.

Request queues decouple the request processing—the mechanism of constructing a specific request in the appropriate request format and encoding from the intent, sequencing, and rate of requests. The sequence of requests in the queue determine the sequence of constructed requests by the downstream request constructor. Periodic requests for the same requested resource, in order to ensure requests meet a certain Service Level Agreement for requested resource coverage in a given time interval, can be specified by carefully inserting request intents for those resources in the queue at intervals and multiplicities that approximate the end desired request issue rate.

At step 350, an embodiment of the invention stores the collected data on a database. using key-value pairs and partitioning said digital media metadata according to a time series, wherein a partition contains said digital media metadata of a given time interval and further using a high-level index that uses time intervals to index each of said key-value pairs. Embodiments of the invention utilize a novel method of storing data in the database, which utilize time-series built on top of key-value pairs. The data to be stored is partitioned by time window (typically a day). A high level index containing the names of the partitions is maintained at memory which allows the user to get the data corresponding to a given time (in this case, a given date). This index is maintained as a TreeMap (which is a sorted map which allows traversing to the subsequent elements in the key).

At step 360, an embodiment of the invention may retrieve data within a time frame. A user may access records within a time frame, by traversing the list of a query from start to end. A high-level index may be maintained as a tree map having sorted elements, thus traversing each element leads to the subsequent element in a list until the end of the list.

This will give the list of individual partitions for each of the time unit (typically, a day). Step 360 may be implemented in a multi-threaded architecture which allows for retrieving data corresponding to the input key from each of the databases concurrently.

The databases may be kyotocabinet .kct files containing key-value pairs. KyotoCabinet is an advanced open-source implementation based on QDBM that offers a whole array of different kinds of underlying storage (both in-memory and permanent) options for key-value pairs that can scale up to 8 exabytes (8000000 Terabytes).

Since this entire database utilizes logical volume management (e.g., LVM 2), where multiple hard disks are striped to form a single large storage area, the data is distributed across the independent disks, which enhances concurrent retrieval of data. In embodiments of the invention, using the latter data storage distributed scheme, a increase of the amount of queried data and/or the complexity of the query itself, which lead to the an increase of number of input/output operations involved for a time series, is carried out over a larger number of disks, thus, resulting in faster operation.

The crawler system of the invention may be implemented as an extensible multithreaded data gathering framework using plugin-based extensible architecture. A system implementing the invention may provide at its core a fault-tolerant multithreaded service for executing and managing instances of any number of plugins. The core is enabled to handle failures, for example, by maintaining a separate pool of failed threads that may be retried at a later time following specified parameters. Parameters such as the number of retrial attempts etc., may be pre-configured or determined from the execution context. The latter architecture allows for delegating site-specific required functionality to specific plugins for accessing any specific target location. The latter framework confers to embodiments of the invention significant advantages such as the the ability to implement target specific requirements within the plugins, thus, each plugin may handle the requirements imposed by the targets, such as, maximum number of requests per seconds, authorization tokens etc.

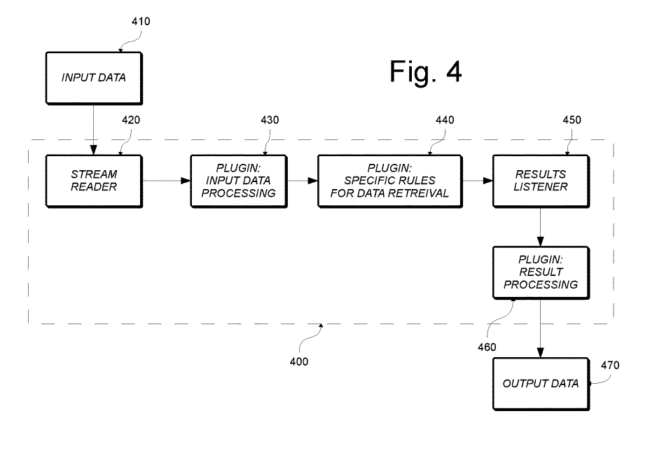

FIG. 4 is a block diagram representing functional components of the system implementing the extensible multithreaded data gathering framework in accordance with an embodiment of the invention. Each component of FIG. 4 represents a set of software code for implementing the methods as described above to collect and process data. The arrows symbolize the flow of data from one component to the next in progression of processing.

Block 410 represents a set of data sources. For example, the location data may be stored in a text file, database, network connection or any other data source location. The system is implemented with software components to access the data and transparently feed input data to the system for processing.

Block 400 represents components of the system according to the framework described above. Block 420 represents software components that enables the system to handle input data and provide streams of data (e.g., URLs data) that can be used by other plugins to crawl sites and access network resources. Block 430 represents software components that process the input data. For example, input data may be used to construct queries, which may involve modifying the input data by adding/removing any specific information to/from the input data. Block 440 represents software components of the system that implement the steps of further implementing specific rules for data retrieval. For example, using the input to determine the target site, the system may determine the specific plugin to invoke for accessing the site. The system may create and manage queues for plugin instances to be created, create and manage queues for instances under execution, and create and manage queues for instances that has returned results or failed to return results.

Block 450 represents software components that enable the system to receive results of the queries. The later may determine whether a query has been successfully executed, failed or needs to be retried.

Block 460 represents software components for handling the results obtained from the crawler's queries. For example, query results may contain several types of data (e.g., metadata, audience feedback etc.) that must be categorized prior to sending the data out to a storage medium and/or to other system components for further processing.

Block 470 represents software components for handling output data streams. The latter may involve further processing for storage. such indexing the data prior to storing the data on a database.

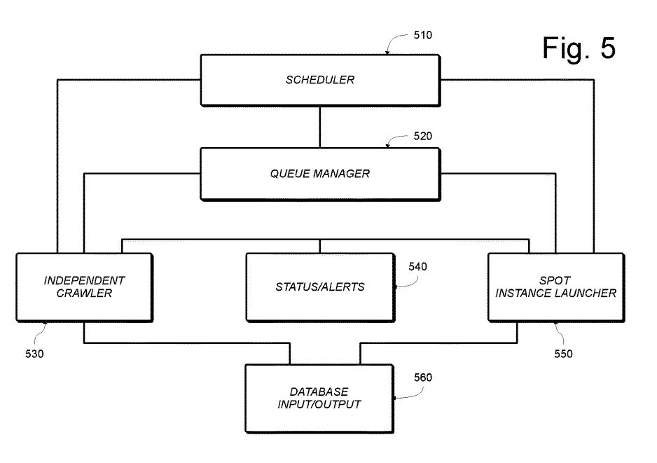

FIG. 5 is a block diagram representing components of a data collection crawling system in accordance with an embodiment of the invention. A crawler system embodying the invention may comprise a scheduling system (e. g., block 510), a queue management system (or queue manager) (e. g., block 520), a crawler process instantiation and management system (e.g., block 530), an instance launcher system (e.g. block 550), a status and alert process management system (e.g., block 540) and data input/output system. The latter crawler system components of FIG. 5 will be described in further detail below.

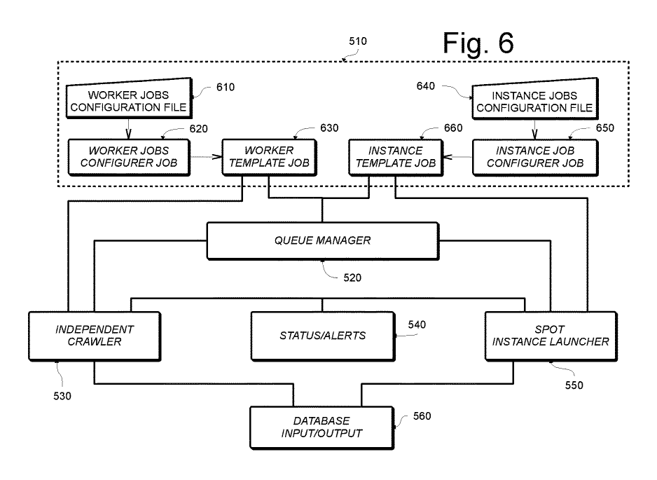

FIG. 6 is a block diagram representing components of a data collection crawling system further detailing a scheduling system in accordance with an embodiment of the invention. The scheduling system 510 comprises software components that enable the system embodying the invention to schedule crawling jobs. A worker job configuration component 620 may utilize a configuration data source 610 (e.g., configuration file) and a worker template 630 to generate and schedule a worker process. A worker process encapsulates mechanisms to address a specific information source using a specific communication protocol particular to that source and issue a request to that source that translates a request intent into the actual request encoding in the communication protocol. The existence of a worker process achieves a separation of concerns between request intent and request construction and issuance and allows the latter to be independently scaled through the judicious selection of an appropriate number of worker processes.

An instance job configuration component 650 may utilize an configuration data source 640 (e.g., configuration file) and an instance template job to generate and schedule an instance job. An instance process encapsulates a macro level crawl intent through aggregating and providing the means of control and coordination between multiple worker instances. These aggregates can be homogeneous or heterogeneous sets of the same or different type of worker instance. It thus allows a logical unit of information desired, to be mapped to one or more request types from one or more source types and organized and controlled as a single unit, enabling ease of use and fine grained control.

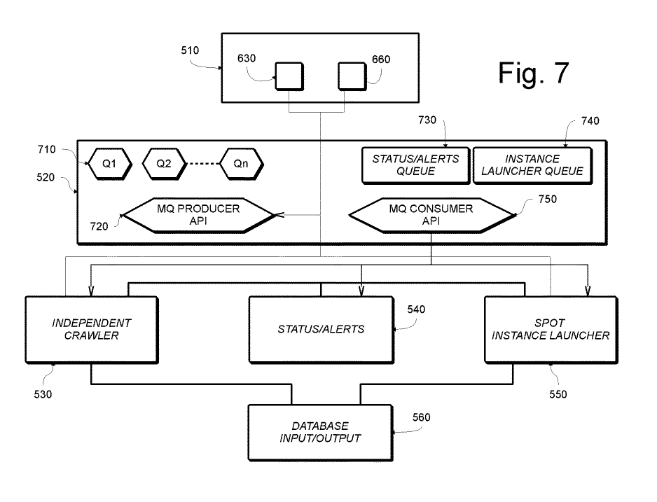

FIG. 7 is a block diagram representing components of a data collection crawling system further detailing a queue management system in accordance with an embodiment of the invention. The queue management system 520 provides an application programming interface (API) component 720 for enabling crawling process instances and instance launcher instances to be interfaced with instance queues. The queue management system 520 provides an API 750 for enabling instance launcher process instances 830 and status/alert process instances 820 to be interfaced with instance launcher process queues and status/alert process queues, respectively. The queue management component provides a single-lever mechanism to control multiple aspects of the request construction and issue process, specifically with reference to the sequence, repetition, and rate. It thus allows independent control over request ordering and request throughput.

Having a single control element in the form of a request queue simplifies the control and management of the system in general as multiple facets of control can be exercised using a single mechanism.

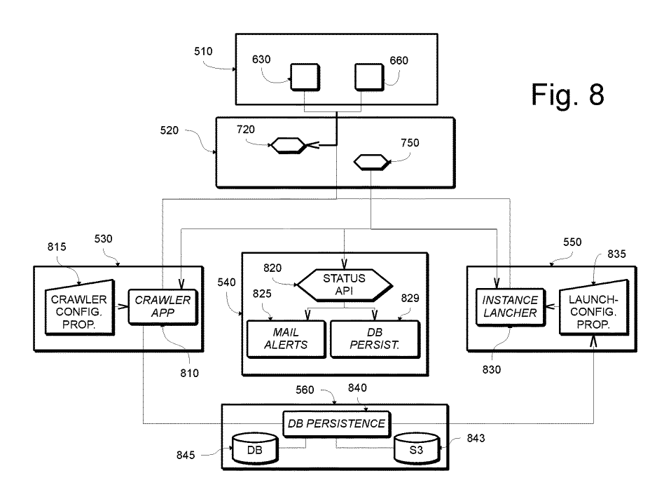

FIG. 8 is a block diagram representing components of a data collection crawling system further detailing the crawler process instantiation and management system, the instance launcher system, the status and alert process management system and the data input/output system in accordance with an embodiment of the invention. The crawler system 530 comprises software component 810 that implement the crawling process i.e. the ability to send network requests and collect data. Many instances may be generated to execute simultaneously. Component 810 may utilize the crawler configuration properties 815 (e.g., from a give data source such as a text file).

The instance launcher 550 comprises software components 830 the execution of which allows for launching process instances, such as crawling process instances (from component 810). Instance launcher component 830 may utilize a launch configuration properties data source (e.g., instance launch configuration properties text file). As described above, an instance launch process is interfaced with the queue manager 520. A system embodying the invention is thus enabled to manage queues for instance launcher process instances.

The status and alert process management component 540 provides an API 820 the implementation of which enables access to communication component 825, such as messaging (e.g., electronic mail), and access to persistent storage (e.g., databases) through component 829.

The instance launcher is enabled to launch instances of the crawling process and the status and alert process. The Instance Launcher component obtains computing resources on which the request queuing, request construction, and request issuance processes can be instantiated and run. The Instance Launcher thus ensures that adequate computing resources of the appropriate nature are available, provisioned, and able to execute request processing steps. The Instance Launcher further attempts to optimize the availability of these computing resources in terms of cost by making judicious decisions regarding the type and number of computing resources made available.

The crawling process, status and alert components provide mechanisms to ensure request construction, issuance, and related processes run successfully, that failures are detected, and that corrective measures can be expeditiously taken if necessary, through evaluating defined conditions that constitute desired correct system behavior (“status”) and notifying appropriate system components in case system behavior deviating from defined correct behavior is detected (“alerts”).

The data input/output component 560 provides an API 840 that is when implemented (e.g., by crawler processes 810) enables access to persistent data storage (e.g., databases 845 and 843). API 840 may also be implemented to access configuration data (e.g., instance launcher configuration properties data).

What is claimed is:

1. A method for gathering and storing digital media metadata, said method is embodied as computer program code that is executed in a system of networked computers and causes said system to retrieve digital media metadata, said system executing said program code enables a creator user to access up-to-date metadata information of digital media thus facilitating the production of context-relevant new media content, said method comprising the steps of:
loading a plurality of input HyperText Transport Protocol (HTTP) request data from at least one data stream into a computer memory as at least one batch for processing;
obtaining a first HTTP request from said plurality of input HTTP request data, wherein said first HTTP request contains a target site data and further optionally contains at least one varying request parameter, and constructing an outgoing HTTP request similar to said first HTTP request;
sending said outgoing HTTP request to said target site and obtaining a response data from said target site, wherein said response data containing a digital media metadata;
removing said first HTTP request from said plurality of input HTTP request data in said at least one batch and loading a second input HTTP request from said at least one data stream into said at least one batch;
storing said digital media metadata on a database using key-value pairs and partitioning said digital media metadata according to a time series, wherein a partition contains said digital media metadata of a given time interval and further using a high-level index that uses time intervals to index each of said key-value pairs; and
retrieving said digital media metadata using a query for a time window.

2. The method of claim 1, wherein said step of loading said plurality of input HTTP request data from at least one data stream further comprising said plurality of input HTTP request data from at least one text file.

3. The method of claim 1, wherein said step of loading said plurality of input HTTP request data from at least one data stream further comprising said plurality of input HTTP request data from at least one network storage location.

4. The method of claim 1, wherein said constructing said outgoing HTTP request further comprising adding to said outgoing HTTP request an identifier for identifying a video media content on said target site.

5. The method of claim 1 further comprising fixing the maximum size of said at least one batch.

6. The method of claim 1, wherein said step of sending said outgoing HTTP request to said target site further comprising retrying said step of sending when said obtaining said response data fails.

7. The method of claim 6 further comprising retrying said step of sending a pre-determined number of times before labeling said send as a permanent failure.

8. The method of claim 1, wherein said step of sending said outgoing HTTP request to said target site further comprising limiting the number of said outgoing HTTP request per time unit.

9. The method of claim 1, wherein said storing said metadata further comprising partitioning said digital metadata by said time window equal to one (1) day.

10. The method of claim 1, wherein said storing said metadata further comprising maintaining said high-level index as a tree map having sorted elements, wherein traversing each element leads to the subsequent element in a list until the end of the list.

11. The method of claim 10, wherein said retrieving said digital media metadata further comprising retrieving a reference in said high-level said partition and retrieving said digital metadata corresponding to said time window.
